(19) United States
(12) Patent Application Publication
(10) Pub. No.: US 2009/0239569 A1
(43) Pub. Date: Sep. 24, 2009

(54) Transmission power reduction in interference limited nodes

(76) Inventors: Martin Dottling, Neubiberg (DE); Michael Farber, Wolfratshausen (DE); Andreas Lobinger, Miesbach (DE); Jurgen Michel, Munchen (DE); Bernhard Raaf, Neuried (DE)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 12/382,525

(22) Filed: Mar. 18, 2009

Related U.S. Application Data
(60) Provisional application No. 61/064,679, filed on Mar. 19, 2008.

(51) Int. Cl. H04B 7/005

(52) U.S. Cl. 455/522; 455/296

(57) ABSTRACT

A method for changing a downlink transmission power level can include receiving information about interference noise. When the interference noise satisfied a predefined level, the downlink transmission power level can be changed. Typically, the transmission power level can be decreased when the interference noise is above a predefined value. The transmission power level change can be coordinated (e.g. coordination in terms of power step size, in terms of frequency portion to which the power change is applied and in terms of time when to apply the transmission power change) with transmission power level changes in other cells. Also, interferences levels may be reassessed following the first transmission power change and the power levels are changes a second time. Optionally, only a portion of the transmission bandwidth is changed or only specific DL physical channels are considered.

### CROSS-REFERENCE TO RELATED APPLICATION

The present application is related to and claims the priority of U.S. Provisional Patent Application No. 61/064,679, filed on Mar. 19, 2008, which is hereby incorporated by reference in its entirety.

### FIELD

Certain embodiments of the present invention generally relate to communications, especially wireless communications. In particular, certain embodiments of the present invention relate to the downlink (DL) transmission of the Universal Mobile Telecommunications System (UMTS) Terrestrial Radio Access Network (UTRAN) long term evolution (LTE). More specifically, certain embodiments of the present invention are related to the Third Generation Partnership Project (3GPP) LTE and about power reduction of Node B power in case of limited interference scenarios.

### BACKGROUND

Wireless communication networks are well known and constantly evolving. For example, UMTS is one of the third-generation (3G) cell phone technologies. Currently, the most common form of UMTS uses wideband code division multiple access (W-CDMA) as the underlying air interface, as standardized by the 3GPP.

Currently, UMTS networks worldwide are being upgraded to increase data rate and capacity for downlink packet data. In order to ensure a further competitiveness of UMTS, various concepts for UMTS Long Term Evolution (LTE) have been investigated to achieve a high-data-rate, low-latency and packet optimized radio access technology.

The 3GPP LTE (Long Term Evolution) is the name given to a project within the Third Generation Partnership Project to improve the UMTS mobile phone standard to cope with future requirements. Goals of the project include improving efficiency, lowering costs, improving services, making use of new spectrum opportunities, and better integration with other open standards. The LTE project is not a standard, but it is expected to result in the new evolved release 8 of the UMTS standard, including mostly or wholly extensions and modifications of the UMTS system.

A characteristic of conventional so-called “4G” networks, including Evolved UMTS, is that they are fundamentally based upon transmission control protocol/internet protocol (TCP/IP), the core protocol of the Internet, with built-on higher level services such as voice, video, and messaging.

In wireless networks, there may be an optimum transmission power level from a Node B. With increased transmission power, the Node B may possibly provide increased transmission quality, but the increased power may result in undesired effects, such as increased interference with a neighboring Node B. Similarly, if the power is reduced too much, the system performance may be degraded. However, operators typically wish to reduce transmission power to conserve energy and resources.

With network planning tools or in an the operation actual network, the power of a Node B can be fine-tuned, and a signal-to-interference-plus-noise ratio (SINR) distribution can be collected from the fine tuning. Typically, operators may want the system to be as energy efficient as possible, so the transmission power is usually initially reduced and the SINR measured. Then, in simulations or during actual operation and management of a system, the transmission power may be increased to determine a minimum DL transmission power level that has acceptably similar performance as the original higher DL transmission power. Disadvantage of this fine tuning power setting method is that the system is sometimes operated with degraded performance until needed appropriate correction can be done.

### SUMMARY

In one embodiment, the present invention is a method including receiving, at a device, information about interference noise. The method also includes, when the interference noise satisfied a predefined level, changing, by the device, the downlink transmission power level.

Another embodiment of the present invention is an apparatus. The apparatus includes a receiver configured to collect information about interference noise. The apparatus also includes a transmitter configured, when the interference noise satisfied a predefined level, to change the downlink transmission power level.

A further embodiment of the present invention is a computer readable storage medium encoded with instruction configured to cause a processor to perform a process. The process includes receiving information about interference noise. The process also includes, when the interference noise satisfied a predefined level, changing the downlink transmission power level.

Another embodiment of the present invention is a method. The method includes collecting and forwarding, by a device, information about interference noise. The method also includes, when the interference noise satisfied a predefined level, receiving, by the device, a downlink transmission having a changed power level.

An additional embodiment of the present invention is an apparatus. The apparatus includes a processor for collecting information about interference noise. The apparatus also includes a transmitter to forward information about interference noise. The apparatus further includes a receiver configured to, when the interference noise satisfied a predefined level, receive a downlink transmission having a changed power level.

A further embodiment of the present invention is a computer readable storage medium encoded with instruction configured to cause a processor to perform a process. The process includes collecting and forwarding information about interference noise. The process also includes, when the interference noise satisfied a predefined level, receiving a downlink transmission having a changed power level.

Another embodiment of the present invention is a method. The method includes defining, by a device, a maximum interference noise level. The method also includes receiving, at the device, measurements regarding interference noise levels in a plurality of cells. The method further includes classifying the cells. The method additionally includes calculating transmission power changes depending on the classification of the cells. The method also includes forwarding, by the device, commands to each class of cells to implement the transmission power changes.

Yet another embodiment of the present invention is an apparatus. The apparatus includes a receiver configured to receive measurements regarding interference noise levels in a plurality of cells. The apparatus also includes a processor configured to define a maximum interference noise level, to classify the cells, and to calculate transmission power changes depending on the classification of the cells. The apparatus further includes a transmitter configured to forward commands to each class of the cells to implement the transmission power changes.

An additional embodiment of the present invention is a computer readable storage medium encoded with instruction configured to cause a processor to perform a process. The process includes defining a maximum interference noise level. The process also includes receiving measurements regarding interference noise levels in a plurality of cells. The process further includes classifying the cells. The process additionally includes calculating transmission power changes depending on the classification of the cells. The process also includes forwarding commands to each class of cells to implement the transmission power changes.

### BRIEF DESCRIPTION OF THE DRAWINGS

For proper understanding of the invention, reference should be made to the accompanying drawings, wherein:

FIG. 1A is a grid depicting a multiple sector communications network in accordance with embodiments of the present invention;

FIG. 1B is a high level schematic diagram of a wireless cell system in accordance with embodiments of the present invention;

FIG. 2A-2B depicting exemplary performance loss from transmission power reductions in accordance with embodiments of the present invention;

FIGS. 3 and 6 depict steps in methods for reducing transmission power in accordance with embodiments of the present invention;

FIGS. 4 and 5 depicts process flow diagrams reducing transmission power in accordance with embodiments of the present invention; and

FIG. 7 is a high-level, schematic diagram that depicts components of a communications system in accordance with embodiments of the present invention.

### DETAILED DESCRIPTION

Certain embodiments of the present invention provide a procedure in which a measurement to avoid going into degraded performance by measuring in advance that optimum setting is achieved.

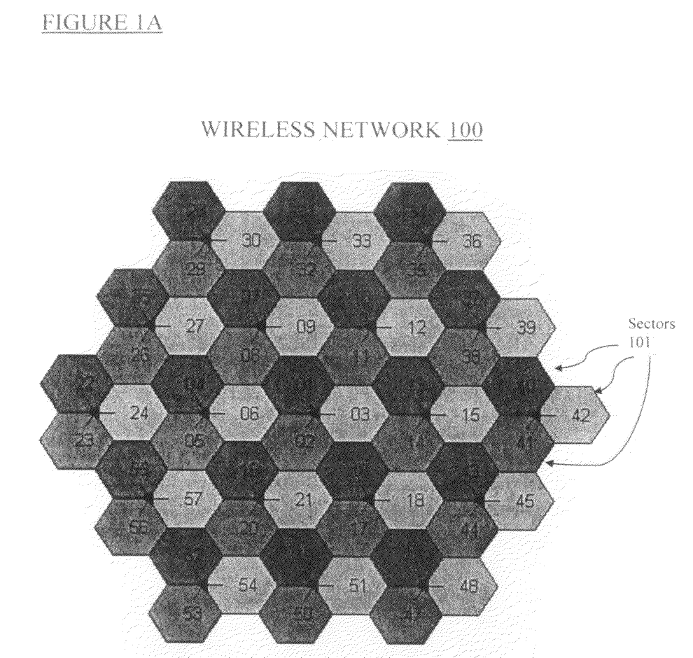

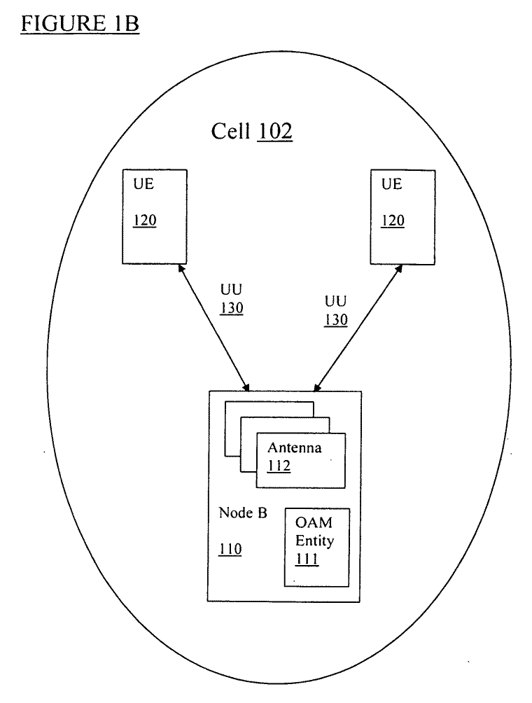

Referring now to FIG. 1A, a network layout 100 having multiple sectors 101 of various types (see three different shadings) is depicted. In particular, the network layout 100 can be configured with 3 different types of sectors 101 on a hexagonal grid, such that identical types of sectors do not come into contact. In FIG. 1A, each of the sectors 101 is designated by a numerical identifier (I) such that I (mod 3)≡1, 2, or 3, and two sectors (identified by I₁ and I₂) of the same type have I₁(mod 3)≡I₂(mod 3). Analysis of a LTE downlink (DL) system in limited interference scenarios often does not show gains by increasing the Node B transmission power. To the contrary, if the Node B transmission power is too high for the deployment scenario, the transmission can be reduced without loss in system performance. The hexagonal representation is used as an example for modeling, explanation and simulation. Real world applications can create cell shapes of non-hexagonal nature. The applied and described methodology discussed herein can work in a similar manner as described for the hexagonal cell shape example. Thus, the hexagonal representation should be viewed as an illustrative example, rather than as the only way that the real-world application of various embodiments of the present invention may be implemented. Thus FIG. 1A simply provides one example implementation.

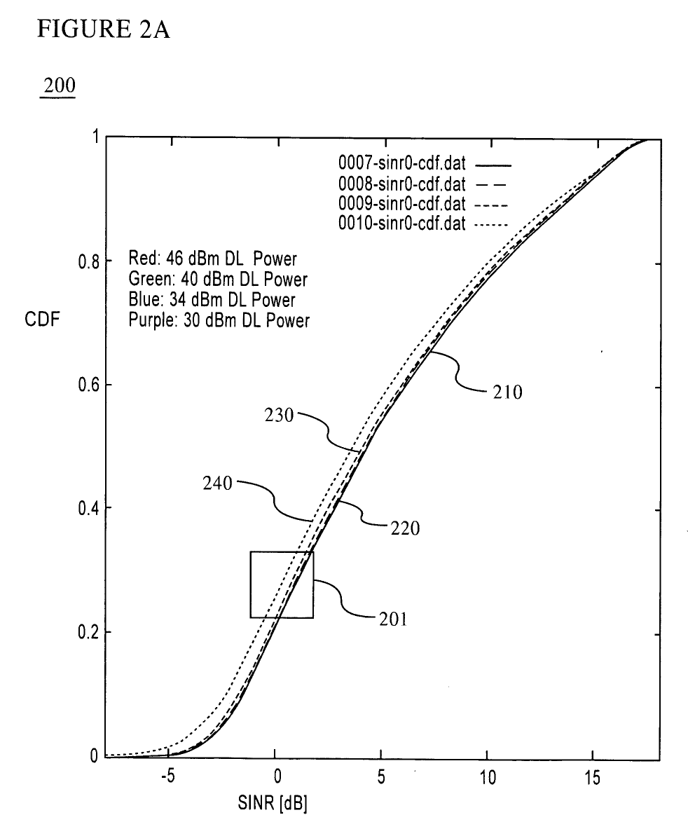

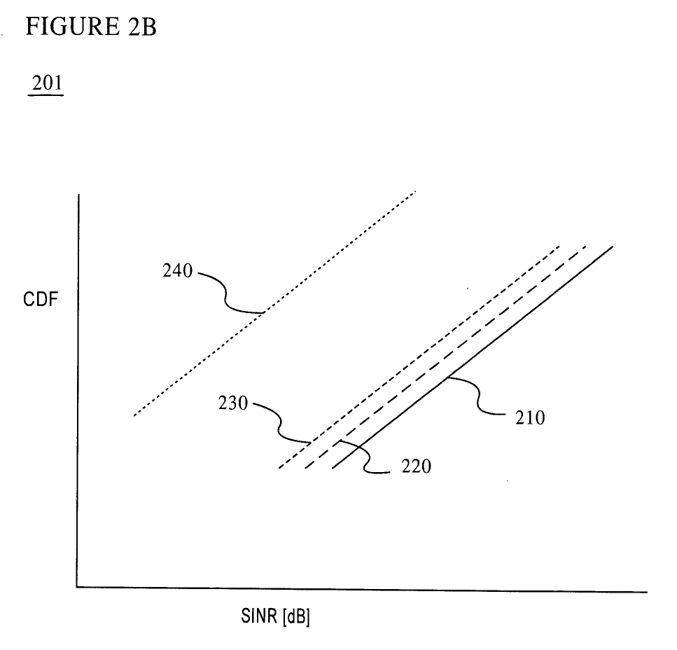

As depicted in chart 200 in FIG. 2A, the downlink signal to interference-plus-noise ratio (DL SINR) distribution in a sector often does not significantly change when DL transmission power is reduced to a certain degree. As with FIG. 1A, FIG. 2A provides simply an example embodiment. The calculation results depicted in chart 200 in FIG. 2 are based upon the network 101 depicted in FIG. 1A having cells with 3 sectors on a hexagonal grid and with an inter-site distance of 500 m. The results depicted in table 200 further assumed a receiver noise figure of 9 dB, a bandwidth of 10 MHz, and no penetration loss. For the given example, the DL transmission power can be reduced from 46 dBm (curve 210), to 40 dBm (curve 220) and then to 34 dBm (curve 230). At 30 dBm (curve 240), the power reduction would harm the system performance as depicted by the degraded resulting SINR distribution of curve 240. From this result, it can be seen that a technical challenge for self-optimizing the DL transmission power to minimize power consumption in the Node B can be to decide to what degree the DL transmission power can be reduced without harming the system performance. Referring to FIG. 2B (which like the other figures merely illustrates an example embodiment), an enlarged portion 201 of the chart 200 depicts in greater detail the relative similarity in the downlink signal to interference-plus-noise ratio (DL SINR) distributions of curves 210, 220, and 230 versus the curve 240.

Referring now to FIG. 1B (which, again, is merely one example embodiment), a UMTS cell 102 in accordance with an example embodiment of the present invention is generally described. In particular, the UMTS cell 102 typically can include one or more Node Bs 110 (known in the LTE as enhanced Node B or eNB) that define one or more sectors 101, and multiple user equipments (UE) 120 associated with one or more of the cells 102. The radio interface between the UE and the Node-B can be referred to as Uu 130.

The Node B 110, also known as a BTS (base transceiver station) in GSM, typically uses wideband code division multiple access (WCDMA) as air transport technology, although this is merely an illustration for the purposes of discussion. The Node B can contain radio frequency transmitter(s) and the receiver(s) used to communicate directly with the mobiles, which can move freely around it or can be in fixed locations in certain embodiments. In this type of cellular network, the UE 120 usually cannot communicate directly with each other but have to communicate via with the Node B 110.

Traditionally, the Node B 110 has minimum functionality and is controlled by an RNC (Radio Network Controller). However, this assumption is changing, for example, with the emergence of High Speed Downlink Packet Access (HSDPA), where some logic (e.g. retransmission) is handled on the Node B for lower response times.

The utilization of WCDMA technology in the LTE can permit cells belonging to the same or different Node Bs 110 and even controlled by different RNCs to overlap and still use the same frequency (in fact, the whole network can be implemented with just one frequency pair) to achieve soft handovers between the cells.

Since WCDMA often operates at higher frequencies than GSM, the cell range can be considerably smaller compared to GSM cells, and, unlike in GSM, the size of the cells may not be constant, in a phenomenon known as cell breathing. This configuration typically requires a larger number of Node-Bs and careful planning in 3G (UMTS) networks. However, the power requirements on the Node Bs 110 and the UE 120 (user equipment) are usually much lower. Optimization of this power, for example in the DL transmissions, is described below using example embodiments.

The Node B 110 typically includes at least one antenna 112 connected to several components, including power amplifiers and digital signal processors (not depicted). The Node B 110 can serve several cells 101, also called sectors, depending on the configuration and type of antenna.

Continuing with FIG. 1B, the UE 120 roughly corresponds to the mobile station in GSM systems and can be any device used directly by an end user to communicate. For example, the UE 120 can be various components that connect to a wireless network to exchange data, including a personal data assistant (PDA), various wireless device, a hand-held telephone, a card in a laptop computer, or other device. Although the UE 120 can be a mobile device, there is no specific requirement that a UE 120 be actually mobile. The UE 120 can connect to the base station, the above-described Node-B as specified in the 25-series of specifications, and roughly corresponds to the mobile station in GSM systems.

The UE 120 typically handles the tasks towards the core network, including: mobility management, call control, session management, and identity management. Generally, the corresponding protocols are transmitted transparently via a node-B 110, such that the node-B 110 does not change, use or understand the protocol information. The UMTS back-end can become accessible via a variety of means, such as a GSM UMTS radio network (GERAN, UTRAN, and E-UTRAN), WiFi, UMB and WiMAX. For example, users of non-UMTS radio networks may be provided with an entry-point into the IP network, with different levels of security depending on the trustworthiness of the network being used to make the connection. Users of GSM/UMTS networks may use an integrated system where all authentication at every level of the system is covered by a single system, while users accessing the UMTS network via WiMAX and other similar technologies would handle the WiMAX connection one way: for example, authenticating themselves via a media access control (MAC) address or electronic serial number (ESN) address, and the UMTS link-up another way.

In LTE Release 8, an air interface called the Evolved Universal Terrestrial Radio Access (E-UTRA) could be used by UMTS operators deploying wireless networks. While the E-UTRA is still being refined, the current E-UTRA systems use OFDMA for the downlink (tower to handset) and Single Carrier FDMA (SC-FDMA) for the uplink and employs multiple-input/multiple-output (MIMO) with up to four antennas per station. The channel coding scheme for transport blocks is turbo coding and a contention-free quadratic permutation polynomial (QPP) turbo code internal interleaver.

The use of OFDM (a system where the available spectrum can be divided into thousands of very thin carriers, each on a different frequency, each carrying a part of the signal) can enable E-UTRA to be much more flexible in its use of spectrum than the older CDMA based systems used in the 3G protocols. CDMA networks typically require large blocks of spectrum to be allocated to each carrier to maintain high chip rates and thus maximize efficiency. OFDM has a link spectral efficiency that is greater than CDMA, and when combined with modulation formats such as 64QAM and techniques as MIMO, E-UTRA is typically more efficient than W-CDMA with HSDPA and HSUPA.

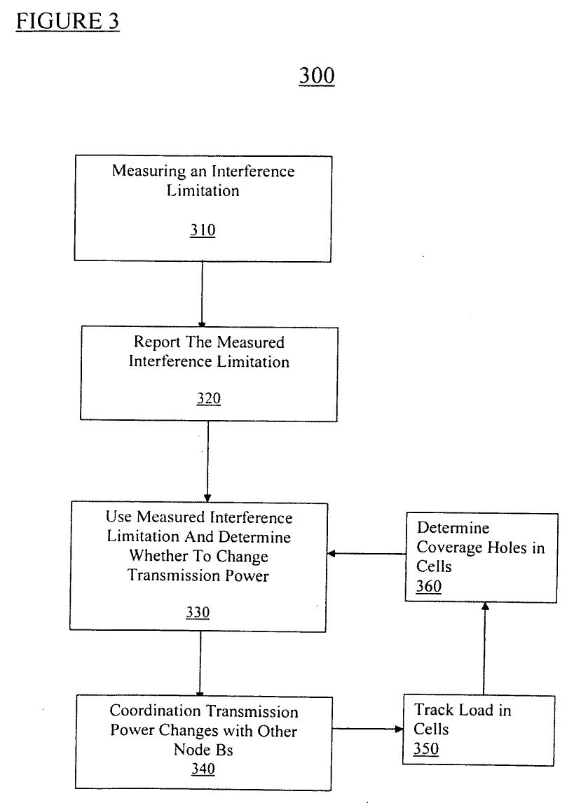

Referring now to FIG. 3 (which is merely an illustration of example embodiments), certain embodiments of the present invention relate to a DL transmission power optimization method 300 that can include measuring an interference limitation in step 310. It should be remembered that FIG. 3 just illustrates certain illustrative embodiments. For example, a quotient of [I+N]/N, where N is a noise measurement at a UE, may be determined in step 310 and reported from the UE to the serving Node B in step 320.

Data obtained as performance data may include, for example, cell load and/or information on whether an interference or noise limitation is prevailing in a particular cell. The impact on user and cell performance indicators can be traced in a system and the system can take countermeasures when degradation is detected. The countermeasures can include reducing downlink transmit power and cell switch off, which should be considered a special case example of reducing transmit power for the purposes of the discussion found herein.

The calculation of noise power (or thermal noise) N at the UE including the UE receiver noise figure NF can be done using equation 1.

N=10*log 10(BW)+N₀+NF (Eq. 1)

where BW is the bandwidth in Hz, N₀=−173.93 dBm/Hz, and NF typically is known by the manufacturer of the UE. The NF can be pre-stored in memory in the UE or a worst case value can be signaled by network and received at the UE. Alternatively, NF may be a predefined estimated value that is used for any UE, regardless of equipment. For example, NF=9 dB is assumed in LTE standardization simulations.

Continuing with FIG. 3, the serving Node B can make a long term statistic in step 330 using the received noise information and can determine whether to reduce DL transmission power. For example, in step 330, if [I+N]/N greater or much greater than 1 or, even more general, if [I+N]/N>k, where k is signaled to the Node Bs for most of the measurements then DL transmission power can be reduced for this Node B. Another embodiment of this approach to making a long term statistic can be that the UE only sends noise information if power reduction is possible without degradation from the specific UE point of view, e.g. only if [I+N]/N>k. This has the advantage that the number of transmitted measurements from the UE to the Node B can be reduced and can be fine-tuned by a parameter signaled from Node B.

Continuing with FIG. 3, however, if there is no similar action (e.g. power reduction or antenna tilting) in the surrounding Node Bs, the coverage area of the other Node Bs can increase, leading to handovers and impact on load balancing. Therefore it may be beneficial to coordinate the power change in step 340. For example, the change can be coordinated by a central OAM entity 111 and power reduction may be performed at the same time and with the same power reduction step in a cluster of adjacent cells 102, thereby achieving the above-described desired power reduction according to the above-described criteria. Another embodiment of this coordination can be that the Node B X2 interface can be used to coordinate the power reduction (or boosting) step in time and frequency domain. The X2 interface can be an interface connecting Node Bs and can permit, for example, signaling of information between neighboring Node Bs.

It is possible that cells adjacent to the cluster of power-reducing cells from steps 310-340, cannot reduce their own power. For example, these adjacent cells may be noise-limited. Consequently, the coverage area for these non-reducing cells can increase, leading to handovers and impact on load balancing. Therefore load indicators of these adjacent cells can be optionally be tracked in step 350 and reported, for example to the OAM entity 111. The power reduction may be altered or even abandoned, the transmission power reverting again in step 320 to original settings, for example, if load indicators are above a certain threshold or if an overload is indicated.

Referring back to FIG. 1A, as a consequence of this and other factors, it may be possible to have system 100 have different power reduction levels at different groups of cells 101. For example, in one implementation, cells at the center of a cluster have higher power reduction, with lower reduction levels toward the edge of the system because as such a power transmission gradient would help to prevent large differences in coverage area.

In general, the noise-limitation (e.g., when [I+N]/N≈1) determined in step 330, typically occurs in the cell center and, in the case of coverage holes, also on the cell edges. The above-described calculations from step 330 can also be used for coverage hole detection if the statistics of [I+N]/N are confined to measurements related to the cell edges. For example, the Node B 110 may use the last measurements of a UE 120 before a handover or measurements from UEs with large timing advance (TA). By taking the statistics over all measurements and over the subset of cell edge measurements, each cell can detect in step 360, whether that cell operates interference-limited (IL), noise limited in the cell center (NL_{c}), or noise-limited in the cell edges (NLₑ), where the superset NL includes both noise-limited in cell center NL_{c} and edges NLₑ.

Another embodiment of what is described above can be to detect an interference-limitation (e.g., when [I+N]/N>>1) instead of noise-limitation. Thus, interference reduction can be accomplished by adapting transmit power, adapting antenna tilt, and/or cell switch on/off, all while maintaining required cell and user performance, as well as network stability.

A large amount of noise-limited measurements at the cell edges can be an indicator of potential coverage holes. If such an event has been detected, countermeasures can be taken. For example, a Node B can increase transmission power if the power has been reduced previously, adapt antenna tilting or inform OAM entities to indicate potential coverage shortage.

Therefore, each Node B in step 360 can optionally report an indication about its status with respect to interference or noise-limitation to the central OAM entity. The OAM entity can then determine the cells involved in the power reduction, individual power reduction targets, as well as configure and coordinate the power reduction procedure in a way that identical power reduction steps may be performed synchronously (or approximately simultaneously) at all involved Node Bs.

In this way, although the above description focuses on power reduction, it should be appreciated that power increases can be managed in the same way. For example, in step 330, by carefully monitoring the new network status and based on several triggers, DL transmission power increases can be triggered and executed as well.

Likewise, although the above description focuses on power reduction of the whole Node B transmission power, it should be appreciated that power reduction and power boosting can be managed on sub-carrier or units of multiple sub-carriers. This means that at the same time (in a time and frequency coordinated way) sub-carriers of neighboring Node Bs are increased, whereas other sub-carriers are reduced and others are unchanged in power. With this embodiment for the decoding of the DL signal, the power profile can be signaled to the UE if multiple sub-carriers scheduled to a UE have different power settings or scheduler may be restricted to schedule UEs only on sub-carriers with the same or very similar power settings.

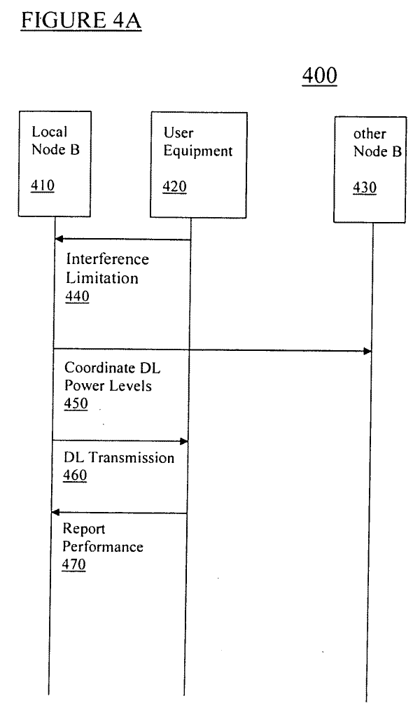

Referring now to FIG. 4, a process flow diagram 400 in accordance with certain embodiments of the present invention is now presented. In particular, the flow diagram 400 depicts the interaction between a Node B 410 and a UE 420. The UE 420 may forward interference limitation data 440. Typically, the interference limitation data 440 is sent as part of a data request message from the UE 420. The Node B 410 can use this data from UE 420 to determine a DL transmission power level. The Node B 410 may forward a message 450 to coordinate the DL transmission power level with other Node Bs 430. The Node B 410 can then create and forward a downlink message 460 to the UE 420. In response to the DL message 460, the UE 420 can forward to the Node B 410 additional performance measurements 470 regarding the impact from the change in the DL transmission power levels.

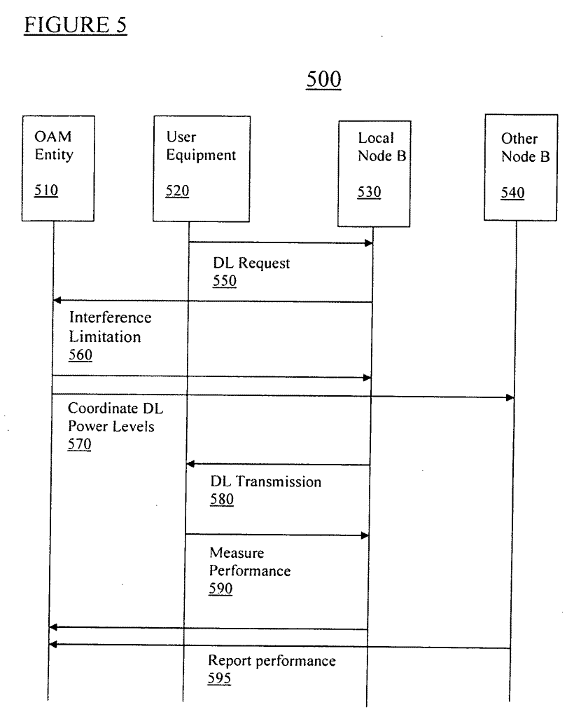

Referring now to FIG. 5 (which, like the other figures, merely illustrates an example embodiment), a process flow diagram 500 in accordance with other embodiments of the present invention is now presented. In particular, the flow diagram 400 depicts the interaction between an OAM Entity 510, a UE 520, a local Node B 530 and another Node B 540 associated with another cell. The UE 520 in the cell may forward a DL request 550 to the local Node B 530 currently associated with the LE, and this DL request 550 can include interference limitation data. The local Node B 530 can then forward the interference limitation data 560 to the OAM entity 510. The OAM entity 510 can use this data 560 to determine appropriate transmission power levels and can forward control signals 570 to the local Node B 530 and another Node B 540 to coordinate the transmission power levels. The Node B 530 can then create and forward a downlink message 580 to the UE 520. In response to the DL message 580, the UE 520 can forward to the local Node B 530 additional performance measurements 590 regarding the impact from the change in the DL transmission power levels. The local Node B 530 and the other Node B 540 may then forward the performance measurement 595 to the OAM entity 510 to reassess the change(s) in transmission power levels.

Thus, it can be seen that noise measurement can typically be performed at the UEs. Then, statistics of measurements can be collected in the Node B. The power of neighboring Node Bs which are interference limited may be synchronously reduced, and this reduction may be optionally controlled by a central OAM element.

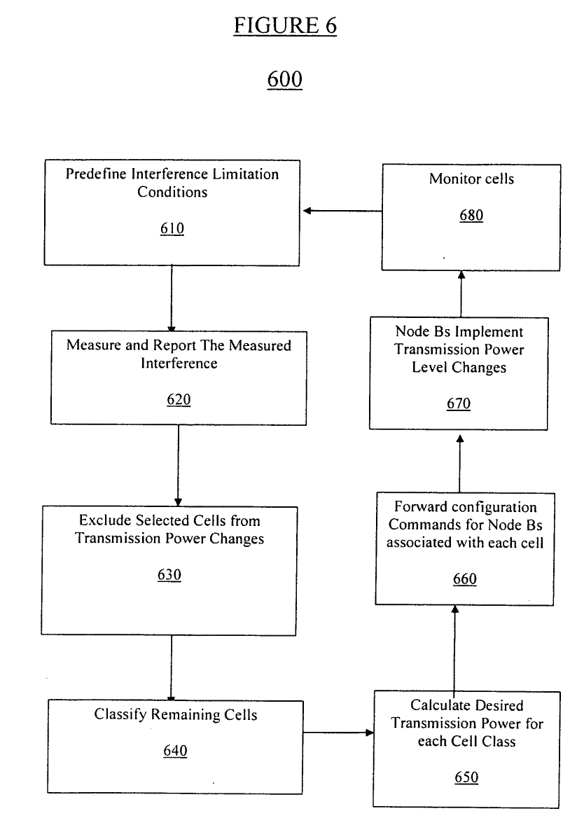

Referring now to FIG. 6, a transmission power reduction method 600 in accordance with another embodiment of the present invention is now presented, but is just an example embodiment. In step 610, threshold conditions are predefined. For example, a central OAM entity may signal the threshold k to the Node Bs. The Node Bs may collect statistics of interference limitation measurements and then report back to the OAM entity their status as either IL, NL_{c}, or NLₑ, in step 620.

Continuing with FIG. 6, the OAM entity may exclude certain cells from power reductions. For example, cells with status NLₑ and their neighbors can be excluded in step 630 from further power reduction procedure since there is a risk of coverage holes that may be worsened by further power reductions. In step 640, the remaining cells can be classified. For example, in step 640, the OAM entity may detect the largest cluster of adjacent cells with status IL (and without neighbors of status NLₑ as explained above), and neighboring cells of the cluster are, hence, NL_{c} and their load status is checked.

In step 650, the power changes can be calculated depending on the classification of the cells. For example, in step 650, a power reduction profile across the cell cluster may be optionally calculated to determine the maximum power reduction in each cell. It should be appreciated that many potential transmission power changing algorithms are conceivable. However, to minimize the impact on load and unnecessary handovers (HO), the maximum power reduction can typically be emphasized towards the edge cells of the cluster in step 650, especially if there is already a significant load in the neighboring cells. In this way, in order to minimize impact on coverage area, a gradual increase in transmission power towards the cluster center may result.

In step 660, after the power reduction profile is calculated, the OAM entity can configure each Node B by forwarding parameters such as maximum power reduction level, the starting time of the power reduction, the step size, and the time interval between power reduction steps. The Node B can then implement the configuration commands from the OAM entity in step 670. In step 670, all Node Bs can start synchronously to reduce the power until the individual maximum power reduction is reached to achieved minimum fluctuations in the coverage area without unnecessary HOs.

Continuing with FIG. 6, the OAM entity in step 680 can monitor the ongoing interference status reports and load reports and can trigger an inverse operation (power increase) similarly to what is described above.

In some implementations, measurements and/or the power reduction in method 600 could be restricted to a sub-band of the total bandwidth, e.g., to certain resource blocks. In this embodiment, the Node Bs are additionally configured in step 660 about the sub-band that is subject to the transmission power change, such as to identify the specific resource blocks to measure/reduce power. For example, network status can be probed with respect to a limited bandwidth in steps 660-670 before the procedure is repeated with more resource blocks, such as to determine the effect of a limited change and to later extend the change to the whole bandwidth. For example, a traffic scheduler could schedule background traffic while doing the probing power reduction, thus minimizing the impact on end user perception during the probing phase.

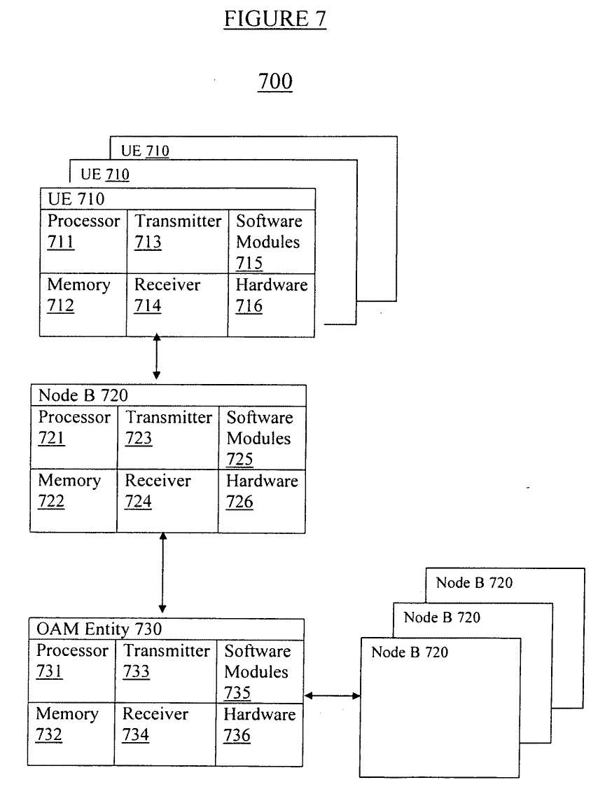

As depicted in FIG. 7, each of the UE 710 in a cell may include a processor 711, memory 712, and input and output devices 713-714. The UE 710 may further include software 715 and related hardware 716 for performing the functions related to forming and broadcasting performance measurements, as discussed elsewhere herein. For example, the UE 710 may monitor, store, and report noise measurements to the Node B 720. Thus, the processing of the interferences measurements may be performed and forwarded transmitted, as needed by circuitry in the hardware 716 or software 715.

Likewise, the Node B 720 may include a processor 721, memory 722, and input and output devices 723-724. The Node B 720 may further include software 725 and related hardware 726 for performing the functions related to calculation of the interference measurements and the resulting changes in transmission power levels. For example, the Node B 720 may include logic in the hardware 726 or the software 725 for calculating an interference limitation and implementing a corresponding change in transmission power levels for a particular UE 710 or for all of the UEs 710 in a cell.

Likewise, an OAM entity 730 may include a processor 731, memory 732, and input and output devices 733-734. The OAM entity 730 may further include software 735 and related hardware 736 for performing the functions related to a calculation of changes in transmission power levels for multiple Node Bs 720 and for coordinating the changes in transmission power levels. For example, the OAM entity 730 may include logic in the hardware 736 or the software 735 for calculating and implementing a corresponding change in transmission power levels for a particular Node B 720 or for multiple Node Bs 720 in multiple cells.

When a device, such as a UE, a Node B, or an OAM, is configured to perform a method, one way in which it can be configured to perform the method is through the use of software embodied in a computer-readable medium, such as a computer-readable storage medium.

In one embodiment, a method includes collecting and forwarding, by a device, information about interference noise. The method also includes, when the interference noise satisfied a predefined level, receiving, by the device, a downlink transmission having a changed power level.

In the method, the transmission power level can be decreased when the interference noise is above a predefined value. Furthermore, the transmission power level can be increased when the interference noise is below a predefined value. The method can also include re-measuring the interferences levels following the first transmission power change and forwarding the re-measured interference levels. In the method, it can be that only a portion of the transmission bandwidth is changed.

Another embodiment of the present invention is a computer readable storage medium encoded with instruction configured to cause a processor to perform a process. The process can be the above-described method in any of its varying embodiments.

A further embodiment of the present invention is an apparatus including a processor for collecting information about interference noise. The apparatus also includes a transmitter to forward information about interference noise. The apparatus further includes a receiver configured to, when the interference noise satisfied a predefined level, receive a downlink transmission having a changed power level.

In the apparatus, the receiver can be configured to receive a downlink transmission having a decreased transmission power level when the interference noise is above a predefined value. Also, the receiver can be configured to receive a downlink transmission having an increased transmission power level when the interference noise is below a predefined value. The processor can be configured to re-measure interferences levels following the first transmission power change and wherein the transmitter is configured to forward the new interferences levels. It can be that only a portion of the transmission bandwidth is changed.

An additional embodiment of the present invention is a method including defining, by a device, a maximum interference noise level. The method also includes receiving, at the device, measurements regarding interference noise levels in a plurality of cells. The method further includes classifying the cells. The method additionally includes calculating transmission power changes depending on the classification of the cells. The method also includes forwarding, by the device, commands to each class of cells to implement the transmission power changes.

The method can also include monitoring, by the device, the interference noise levels in the cells. The classification can include excluding certain cells having interference noise level that exceed the maximum. It can be that only a portion of the transmission bandwidth is changed.

Another embodiment of the present invention is a computer readable storage medium encoded with instruction configured to cause a processor to perform a process. The process can be the above-described method in any of its varying embodiments.

An additional embodiment of the present invention can be an apparatus including a receiver configured to receive measurements regarding interference noise levels in a plurality of cells. The apparatus also includes a processor configured to define a maximum interference noise level, to classify the cells, and to calculate transmission power changes depending on the classification of the cells. The apparatus further includes a transmitter configured to forward commands to each class of the cells to implement the transmission power changes.

The receiver can be further configured to monitor the interference noise levels in the cells. The processor can be configured to exclude certain cells having interference noise level that exceed the maximum. The processor can be configured to change only a portion of the transmission bandwidth.

One having ordinary skill in the art will readily understand that the invention as discussed above may be practiced with steps in a different order, and/or with hardware elements in configurations that differ from those discussed above. Therefore, although the invention has been described based upon these embodiments, it would be apparent to those of skill in the art that certain modifications, variations, and alternative constructions would be apparent, while remaining within the spirit and scope of the invention.

We claim:

1. A method, comprising:
receiving, by a device, information about interference noise; and
when the interference noise satisfied a predefined level, changing, by the device, the downlink transmission power level.

2. The method of claim 1, wherein the changing the transmission power level comprises decreasing the transmission power level when the interference noise is above a predefined value.

3. The method of claim 1, wherein the transmission power level change is coordinated with transmission power level changes in other cells.

4. The method of claim 1, further comprising:
reassessing interferences levels following the first transmission power change; and
changing the power levels a second time based on the reassessment.

5. The method of claim 1, wherein the changing the transmission power level comprises increasing the transmission power when the interferences levels is below a predefined value.

6. The method of claim 1, wherein the changing the transmission power level comprises changing only a portion of the transmission bandwidth.

7. An apparatus, comprising:
a receiver configured to collect information about interference noise;
a transmitter configured, when the interference noise satisfied a predefined level, to change the downlink transmission power level.

8. The apparatus of claim 7, wherein the transmitter is configured to decrease the transmission power level when the interference noise is above a predefined value.

9. The apparatus of claim 7, wherein the transmitter is configured to coordinate the transmission power level change in terms of power level steps and synchronize the transmission power level change in time with transmission power level changes by network elements in other cells by forwarding a message from the transmitter.

10. The apparatus of claim 7, further comprising:
a processor configured to reassess interferences levels following the first transmission power change,
wherein the transmitter is configured to change the power levels a second time responsive to the reassessment.

11. The apparatus of claim 7, wherein transmitter is configured to increase the transmission power when the interferences levels is below a predefined value.

12. The apparatus of claim 7, wherein transmitter is configured to change only a portion of the transmission bandwidth.

13. A computer readable storage medium encoded with instruction configured to cause a processor to perform a process, the process comprising:
receiving information about interference noise; and
when the interference noise satisfied a predefined level, changing the downlink transmission power level.

14. The computer readable storage medium of claim 13, wherein the changing the transmission power level comprises decreasing the transmission power level when the interference noise is above a predefined value.

15. The computer readable storage medium of claim 13, wherein the transmission power level change is coordinated with transmission power level changes in other cells.

16. The computer readable storage medium of claim 13, further comprising:
reassessing interferences levels following the first transmission power change; and
changing the power levels a second time based on the reassessment.

17. The computer readable storage medium of claim 13, wherein the changing the transmission power level comprises increasing the transmission power when the interferences levels is below a predefined value.

18. The computer readable storage medium of claim 13, wherein the changing the transmission power level comprises changing only a portion of the transmission bandwidth.
